(19) United States
(12) Patent Application Publication
(10) Pub. No.: US 2024/0119547 A1
(43) Pub. Date: Apr. 11, 2024

(54) GENERATING LEGAL RESEARCH RECOMMENDATIONS FROM AN INPUT DATA SOURCE

(71) Applicant: Thomson Reuters Enterprise Centre GmbH, Zug (CH)

(72) Inventors: Carol Jo Steffen Lechtenberg, St. Paul, MN (US); Merine Thomas, Eagan, MN (US); Thomas Vacek, Cedar Park, TX (US); Paras Sethia, Toronto (CA); Zachary Malenick, Woodbury, MN (US); Sara Grapentine, Oakdale, MN (US); Andrew Timothy Mulder, Orleans (CA)

(21) Appl. No.: 18/482,840

(22) Filed: Oct. 6, 2023

Related U.S. Application Data
(60) Provisional application No. 63/414,001, filed on Oct. 7, 2022.

(51) Int. Cl. G06Q 50/18; G06F 16/33

(52) U.S. Cl. CPC G06Q 50/18; G06F 16/3334

(57) ABSTRACT

Embodiments of the present disclosure support systems and methods providing functionality for identifying legal authorities from input data that does not contain legal citations. The legal authorities may be identified by first extracting a set of features from input data. The set of features may be used to identify a set of candidate legal authorities. The set of candidate legal authorities may be ranked and/or pruned to produce a set of legal authorities that are highly relevant to legal issues and facts within the input data.

### CROSS-REFERENCE TO RELATED APPLICATIONS

The present application claims the benefit of and priority to U.S. Provisional Application No. 63/414,001, filed Oct. 7, 2022, and entitled “SYSTEMS AND METHODS FOR GENERATING RESEARCH RECOMMENDATIONS,” the content of which is incorporated herein by reference in its entirety.

### TECHNICAL FIELD

The present disclosure relates generally to search automation technology and more particularly to techniques for automatic generation of legal research recommendations.

### BACKGROUND

Many documents rely on the content of other documents when making assertions or providing conclusions. For example, in a first legal case treating a legal issue or point of law, the legal case may rely on a decision or treatment of the issue in a second case. In this sense, the first case may cite the second case. In some cases, lawyers and legal researchers may desire to research a legal issue or a point of law based on a topic of interest or a document they have access to. Such documents may include, for example, an email from a client explaining their factual circumstances and identifying a legal problem or a motion filed by an opposing party in a legal case. To analyze the legal issues in such documents, a researcher may access and review a large volume of cases, such as by reviewing the citations in a first case. Reviewing the citations may also provide an easy method to expand the scope of understanding on a topic in the legal case.

However, not all citations may be useful for a user, and not all legal cases or documents of interest include a citation list. A researcher may be left on their own to independently and manually search for any relevant documents related to the document or topic of interest. While conventional search systems may return a plurality of cases in response to a particular query, any greater level of analysis to determine if a particular search result is related to the document or topic of interest would also require manual review. Such manual review may create inaccurate areas of research thus leading to dead ends. Manual review may also be time consuming and likely beyond what is permitted by the client if paid for as part of legal representation.

Citation systems lack functionality to address the above situation where conventional search results are presented at best as a long list of cases for review that do not include any indications of relevance. Thus, there remains a need to identify legal authorities based on input data, including documents or topics of interest in a more meaningful way that has increased functionality than simple result lists.

### SUMMARY

Embodiments of the present disclosure provide systems, methods, and computer-readable storage media supporting operations to automatically extract features from input data and use the extracted features to identify candidate legal authorities relevant to the input data in law and in fact. Such functionality enables the disclosed embodiments to provide meaningful, relevant, and robust responses to one or more legal issues present a diverse range of input data types even when relevant legal authorities are unknown or unspecified in the input data and/or when the input data contains unstructured content (e.g., an e-mail). The disclosed techniques may also filter the candidate legal authorities to eliminate noise within the candidate legal authorities and then rank the resulting candidate legal authorities with respect to relevance to the one or more legal issues detected in the input data, thereby returning a set of candidate legal authorities to the user that are more relevant to the legal issue(s). Such capabilities represent an improved search engine for supporting a legal citation system that overcomes drawbacks of prior legal citation systems that were incapable of detecting relevant legal authorities from an input dataset without citations.

Consider the following illustrative example in which a lawyer or other legal researcher receives an email containing an assignment to research a legal issue (e.g., a point of the law as it relates to a set of facts and circumstances of a client, or the answer to a legal question). In such an example, the lawyer or legal researcher may desire to identify legal authorities relevant to the legal issue by using the email itself as input data to a legal search system, such as, for example, Westlaw Precision®, Westlaw Edge®, or Westlaw Quick Check®. In accordance with the present disclosure, a legal search system may receive the e-mail as input and then identify and output legal authorities relevant to questions and issues presented the email.

Similarly, a lawyer or legal researcher may desire to supplement their work on a draft brief or memo that does not include citations to legal authorities by using that draft as input data to a system configured to retrieve relevant cases in accordance with the concepts described herein. As yet another example, a lawyer may wish to quickly check the authorities cited by another lawyer representing a party adverse to the lawyer's client to determine the strength of the other side's case. The systems and methods as discussed in this disclosure enable such input data to be provided such that relevant legal authorities are identified and provided to a user as a result.

According to aspects of the disclosure, described herein is a system comprising, a memory and one or more processors coupled to the memory. The one or more processors may be configured to extract a set of data segments from input data. The input data includes information associated with one or more legal issues (e.g., implicitly or explicitly stated legal issues) but does not contain citations to legal authorities. The one or more processors may be configured to identify a set of features in the set of data segments extracted from the input data. The set of features may correspond to the one or more legal issues, which may be related to one or more points of law, a set of facts, or a combination thereof. The one or more processors may be configured to determine a set of candidate legal authorities based on the set of features. The set of candidate legal authorities are determined based on a query of a data source based on the set of extracted features and may include legal documents (e.g., case law documents, journal articles, statutes, and the like). The one or more processors may be configured to prune the set of candidate legal authorities to generate a reduced set of candidate legal authorities and output a ranked set of legal authorities based on the reduced set of candidate legal authorities.

According to aspects of the disclosure, described herein is a method for generating a set of legal authorities from input data that does not include citations. The method includes extracting, by one or more processors, a set of data segments from input data. The input data may include information associated with one or more legal issues, facts, or a combination thereof, but does not contain citations to legal authorities. The method also includes identifying, by the one or more processors, a set of features in the set of data segments extracted from the input data. The set of features may correspond to the one or more legal issues and related to one or more points of law, a set of facts, or a combination thereof. The method also includes determining, by the one or more processors, a set of candidate legal authorities based on the set of features. The set of candidate legal authorities may be determined based on a query of a data source based on the set of features, and the set of candidate legal authorities may include legal documents (e.g., case law documents, journal articles, statutes, and the like). The method includes pruning, by the one or more processors, the set of candidate legal authorities to generate a reduced set of candidate legal authorities; and outputting, by the one or more processors, a ranked set of legal authorities based on the reduced set of candidate legal authorities.

In some aspects, a non-transitory computer readable medium storing instructions that, when executed by one or more processors, cause the one or more processors to perform operations for generating a set of legal authorities from input data that does not include citations is disclosed. The operations include extracting a set of data segments from input data. The input data may include information associated with one or more legal issues but does not contain citations to legal authorities. The operations also include identifying a set of features in the set of data segments extracted from the input data. The set of features may correspond to the one or more legal issues and be related to one or more points of law, a set of facts, or a combination thereof. The operations include determining a set of candidate legal authorities based on the set of features. The set of candidate legal authorities may be determined based on a query of a data source based on the set of features, and wherein the set of candidate legal authorities comprise legal documents (e.g., case law documents, journal articles, statutes, and the like). The operations may include pruning the set of candidate legal authorities to generate a reduced set of candidate legal authorities and outputting a ranked set of legal authorities based on the reduced set of candidate legal authorities.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF DRAWINGS

For a more complete understanding of the present disclosure, reference is now made to the following descriptions taken in conjunction with the accompanying drawings, in which:

FIG. 1 shows a block diagram of a system for generating a set of legal authorities in accordance with aspects of the present disclosure;

FIG. 2 shows a block diagram illustrating an exemplary process for generating a set of legal authorities in accordance with aspects of the present disclosure; and

FIG. 3 is a flow diagram of an exemplary method for generating a set of legal authorities in accordance with aspects of the present disclosure.

It should be understood that the drawings are not necessarily to scale and that the disclosed aspects are sometimes illustrated diagrammatically and in partial views. In certain instances, details which are not necessary for an understanding of the disclosed systems, methods and apparatuses or which render other details difficult to perceive may have been omitted. It should be understood, of course, that this disclosure is not limited to the particular aspects illustrated herein.

### DETAILED DESCRIPTION

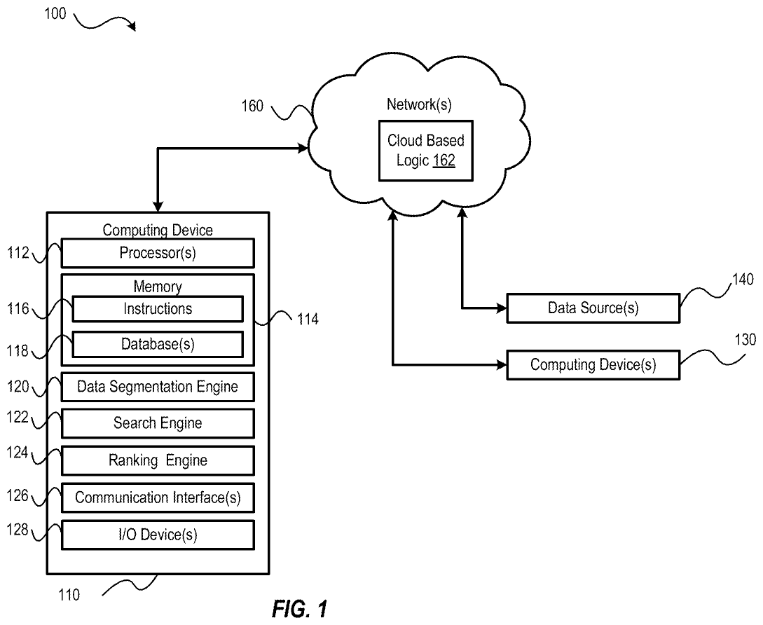

Referring to FIG. 1, a block diagram of a system for generating a set of legal authorities in accordance with aspects of the present disclosure is shown as a system 100. As described in more detail below, the system 100 is configured to generate a set of legal authorities associated with legal authorities identified based on features extracted from input data. As described in more detail below, the system 100 identify candidate legal authorities relevant to the input data in law and in fact. For example, aspects of the present disclosure may enable a user to provide, as input data, an email or a document that contain information related to a legal issue (e.g., an implicitly stated or explicitly stated legal issue), but does not contain citations to any legal authorities. The system provides functionality to extract data segments from the input data related to the legal issue(s). The extracted data segments may include features that may be used to identify case law documents or other legal authorities relevant to the legal issue(s). For example, the extracted data segments may be used to generate a query of a data source to retrieve case law documents or legal authorities related to the legal issue(s). The system may also provide functionality for eliminating noise and ranking the identified legal authorities such that the most relevant authorities are presented to the user for review. The above-described functionality provided by the system 100 represents a technical improvement to search engine technology for legal citation and research systems by enabling searches for legal authority to be initiated using input data that does not contain citations to legal authority. Furthermore, the above-described functionality also eliminates noise in the results returned by the search, thereby improving the quality of the search results and improving the relevancy of the results presented to the searcher. Other benefits of the above-described functionality may also be realized because of the improvements described above. For example, researchers may be able to spend more time on analysis of the search results instead of iteratively creating search terms and then refining them after sifting through the results. In an aspect, the system 100 may also provide functionality for searching data sources, including, for example, databases, for documents relevant to the legal issue. Exemplary details regarding the above-identified functionality of the system 100 are described in more detail below.

As illustrated in FIG. 1, the system 100 includes a computing device 110. The computing device 110 may be configured to identify legal issues from input data and perform searches for legal authorities (e.g., case law documents, administrative rules, and/or statutes) addressing or setting forth the law related to the legal issues. It is noted that while shown as computing device 110, the same or similar functionality may be provided by other implementations, such as through cloud-based logic 162, through a distributed computing system, or other computing methods. As shown in FIG. 1, the computing device 110 may include one or more processors 112, a memory 114, a data segmentation engine 120, a search engine 122, a ranking engine 124, one or more communication interfaces 126, and input/output (I/O) devices 128. The one or more processors 112 may include a central processing unit (CPU), graphics processing unit (GPU), a microprocessor, a controller, a microcontroller, a plurality of microprocessors, an application-specific integrated circuit (ASIC), an application-specific standard product (ASSP), or any combination thereof. The memory 114 may comprise read only memory (ROM) devices, random access memory (RAM) devices, one or more hard disk drives (HDDs), flash memory devices, solid state drives (SSDs), other devices configured to store data in a persistent or non-persistent state, network memory, cloud memory, local memory, or a combination of different memory devices. The memory 114 may also store instructions 116 that, when executed by the one or more processors 112, cause the one or more processors 112 to perform operations described herein with respect to the functionality of the computing device 110 and the system 100. The memory 114 may further include one or more databases 118, which may store data associated with operations described herein with respect to the functionality of the computing device 110 and the system 100.

The communication interface(s) 126 may be configured to communicatively couple the computing device 110 to the one or more networks 160 via wired or wireless communication links according to one or more communication protocols or standards. Network connections may allow the computing device 110 to communicate with and/or take advantage of resources similarly connected to the one or more networks 160, such as the one or more computing devices 130, the one or more data sources 140, and the cloud-based logic 162. The I/O devices 128 may include one or more display devices, a keyboard, a stylus, one or more touchscreens, a mouse, a trackpad, a camera, one or more speakers, haptic feedback devices, or other types of devices that enable a user to receive information from or provide information to the computing device 110.

The one or more databases 118 may be configured to store data, such as, for example, documents, metadata, and/or other pieces of information useful in performing data segmentation operations. As a non-limiting and illustrative example, the data may include legal documents, such as case law documents, (e.g., decisions from courts of various geographical or subject matter jurisdictions, and/or decisions from courts from various legal hierarchies within a given jurisdiction), training datasets (e.g., training, validation, and testing datasets), statutes, legal codes, legal briefs, legal motions, journal articles, and/or treatises. In some aspects, legal documents may also be considered legal authorities. For example, a legal document may establish or confirm a point of law in the jurisdiction corresponding to the legal document, or it might identify and/or define how a legal issue is treated in the jurisdiction. In some aspects, a legal document may establish authority with respect to a result under the law for a given set of factual circumstances.

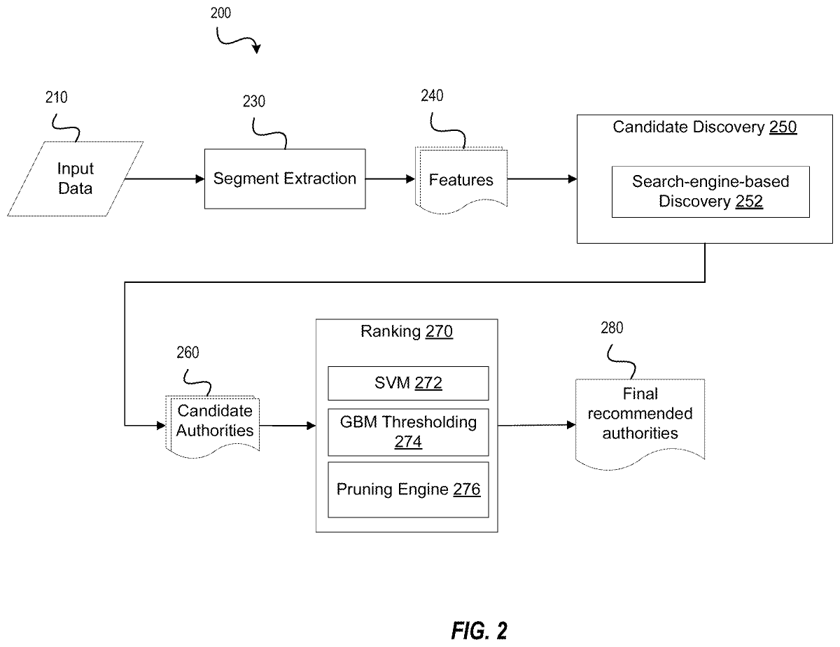

The data segmentation engine 120 of FIG. 1 may be configured to extract data segments from input data provided to the computing device 110. The data segments may include features that may be used to define a query of a data source, such as the data source(s) 140 or the database(s) 118, to obtain legal authorities or documents relevant to one or more legal issues identified in the input data. For example, and referring to FIG. 2, a block diagram illustrating an exemplary process for generating a set of legal authorities in accordance with aspects of the present disclosure as a process 200. Process 200 may begin upon receipt of input data 210. The input data 210 may include a document, an e-mail, or other types of data containing text. In an aspect, the input data 210 may be a legal document, such as a pleading, a court filing, a brief, a journal article and the like. In an additional or alternative aspect, the input data 210 may include an email, a letter, a non-authoritative discussion, an article, a blog post, a memo, or similar types of information. It is noted that the input data 210 may be a draft version of one of the preceding non-limiting examples of the various types of information that may be provided as input data. In an aspect, the input data 210 may be provided by uploading a document (e.g., to the computing device 110 of FIG. 1). In an additional or alternative aspect, the input data 210 may be provided by copying and pasting or typing the input into a text box provided via a graphical user interface (GUI), such as a GUI providing the functionality descried herein. In an aspect, the input data 210 does not contain citations to legal authorities, such as case law. However, it is noted that the techniques disclosed herein may be readily applied to input data that does contain citations to legal authorities or that includes one or more issues for which no legal authority is cited and others in which some legal authority is cited. In such instances, the process 200 may be utilized to identify legal authorities for any issues that do not contain citations to legal authorities and/or to supplement any citations to legal authorities. Citations, also referred to herein as legal citations, may include a reference to a source of law, (e.g., a statute, court case decision, administrative rules, the results of a proceeding, a legislative history, and/or other authoritative sources of law), a reference to a binding source of law (e.g., a statute applicable in a particular jurisdiction and/or a precedential court case), a reference to an analogous source of law, a reference to a comparative source of law, a reference to a contradictory point of law, a reference to a scholarly article (e.g., a journal article, a collection of cases, a legal commentary, or a treatise), a reference to another legal document (e.g., a brief, a motion, an administrative filing, or the like), or any combination thereof. It is noted that in situations where the input data 210 includes legal citations for some but not all issues at hand, the process 200 may seek to identify legal authority for those issues for which there are no legal citations and other existing techniques may be applied to validate any legal citations that are included in the input data 210, such as to verify the legal authority cited to has not been overruled or received negative treatment, find additional legal authority to support any cited legal authorities included in the input data, or other types of validations.

As will be described in more detail below, the process 200 provides functionality to analyze the input data 210 to detect a set of features (e.g., one or more legal issues, facts, and the like) and then use the set of features to identify a set of legal authorities that may be returned in response to the input. In this manner, a researcher seeking to establish a position or argument in favor of a particular result to be achieved with respect to the one or more legal issues and/or set of facts may be able to quickly identify relevant legal authorities without needing to start with a citation to a legal case or trying different keyword combinations to search for case law. It is noted that existing search engines used by legal researchers typically require citations and/or keywords as inputs, rather than the types of inputs contemplated by the process 200. Instead, the process 200 is able to automatically generate search queries using the features extracted from the input data 210, as described in more detail below and then output relevant results to the researcher, thereby reducing the amount of time required to identify relevant legal authority and reducing the number of searches that may need to be performed, which may reduce the computing resources (e.g., reduce processing resources and memory resources) needed to perform searching at scale. It is noted that the input data 210 may also include other types of inputs if desired. For example, the input data 210 may include information identifying one or more jurisdictions of interest (e.g., the legal authorities identified using the concepts described herein should be limited to a particular court, circuit, state, etc.), specific types of legal authority (e.g., case law documents only, case law and journal articles, etc.), or other types of parameters that may be used to identify legal authority using the techniques described herein.

As shown at block 230, the data segmentation engine 120 of FIG. 1 may be configured to extract a set of data segments from the input data 210. For example, the data segmentation engine 120 may include machine learning (ML) and/or rules-based logic configured to determine, extract and/or generate a set of data segments from the input data. In an aspect, the set of data segments extracted by the data segmentation engine 120 may include a set of text-based elements, such as keywords, phrases, sentences, or other portions of the input data 210 that may provide information that may be used to identify one or more legal authorities relevant to the input data 210. For example, the segmentation may utilize natural language processing (NLP) to analyze text within the input data 210 and to convert the text into a form that may be analyzed using an ML model. The NLP may include processes such as stemming, lemmatization, normalization, and tokenization (e.g., converting text to numerical form suitable for input to an ML model), as non-limiting examples. Normalization may include expanding contractions such as “couldn't” to “could not” and deleting punctuation marks (e.g., periods, commas, semi-colons, etc.), special symbols, stop words (e.g., “a”, “an”, “the”, etc.), hypertext markup language (HTML) tags (e.g., uniform resource locators (URLs)), special symbols, non-English words, and the like from the input data 210. The stemming and lemmatization may be configured to remove suffixes from words, such as to remove “ing”, “ed”, or other suffixes from words present in the input data 210. The stemming and lemmatization may also be configured to group different forms of a word to analyze them as a single root word (e.g., “disappointment” and “disappointing” to “disappoint”, etc.).

In contrast to some systems that may be capable of extracting existing citations from a document (i.e., a complete or substantially complete document with well-developed arguments supported by citations), the input data 210 may not have well defined sections that may be identified to detect relevant portions of the input data 210 in which information that may be used to form the basis of a search for citations can be found (e.g., a draft brief with some sections not defined or text that is incomplete. Additionally, the input data 210 may be in a form that does not include any type of sections or heading that may be used for analysis (e.g., an e-mail may just be one or more paragraphs of text or bullet points). In an aspect, such unstructured text may be addressed during segment extraction via a set of segment extraction rules configured to control how and where segments are extracted from the input data 210. For example, the set of segment extraction rules may be used to identify sections within a document (e.g., a draft brief or motion), such as an introduction section, an argument section, a conclusion section, and the like, that may contain information from which one or more legal issues may be identified, one or more facts may be detected, and the like, where such detected segments may be used to generate a query configured to identify citations to legal authority relevant to the one or more legal issues, one or more facts, or a combination thereof. As a non-limiting example, the set of segment extraction rules may be configured to detect sections within a document (e.g., via detection of section heading, a table of contents, and the like), where one or more of the sections may be determined to be likely to contain information that may be used to generate a search for relevant citations to legal authorities. As another non-limiting example, the set of segment extraction rules may be configured to detect portions of the input data 210 that need not be analyzed for information relevant for constructing a query. To illustrate, the set of segment extraction rules may be configured to detect different portions of an e-mail, such as an e-mail addresses section (e.g., associated with the sender and one or more recipients), a subject line, and a body of the e-mail. The set of segment extraction rules may be used to detect the subject line and/or at least a portion of the body of the email for analysis while contents of the e-mail address section may be ignored as irrelevant. It is noted that in some instances the input data 210 may not include the actual e-mail and may instead only include the contents of the body portion of the e-mail (e.g., via a copy and paste action).

By applying the rules to the input data 210, portions of the input data 210 providing information useful for identifying a set of authorities (e.g., citations to legal cases, statutes, journal articles, and the like) may be detected within the input data 210. For example, the portions of the input data 210 identified based on the set of rules may be more likely to include issue statements (e.g., text indicating one or more legal issues of interest), statements of facts (e.g., text identifying facts related to the one or more legal issues of interest), arguments (e.g., text associating facts to one or more legal issues of interest), and/or other portions of the input data 210 that may be used to identify citations to legal authority relevant to the one or more legal issues of interest and/or the set of facts. Thus, the set of rules may reduce the computational resources needed to extract segments from the input data 210 (e.g., by locating specific portions of the input data 210 containing information that may be used to locate or identify a set of relevant legal authorities, such as case law documents, statutes, and the like) as compared to other approaches (e.g., document comparison approaches, etc.). Moreover, the rules may enable the segmentation to be applied to many different types of input data, including e-mails, draft documents with formatting (e.g., section headers, styles, etc.), draft documents without headers (e.g., e-mails, documents without section headers, styles, etc.), and other types of input data that does not contain citations. For example, the rules may identify section boundaries within the input data (e.g., a document, an e-mail, or other input containing text) based on the style of a text, such as by detecting text having a bold, underlined, or italic style, which may be detected by the rule as a section heading within a document, even if the relevant text does not have heading, formatting, and/or metadata. Additionally, the rules may be configured to evaluate other types of text formatting, such as whether the text is offset (e.g., indented) from other text or center aligned. By detecting headers and sections within the input data in this manner, section boundaries may be identified even when metadata and section boundary styles are not included in the input data. In other words, the presence of such formatting may function as a heading, meaning it is likely that a previous section or segment of the document has ended. The rules may also be configured to evaluate the text of the detected headings to identify argument sections (e.g., by looking for keywords such as “Argument”, “Analysis”, etc.) or other types of relevant document sections from which information that may be used to identify legal authority may be extracted. In analyzing a structure of the input data, the rules may also be configured to combine sections or omit portions of the input data from further consideration. For example, the rules may be used to identify sections (e.g., portions of the input data) containing information for consideration when seeking to identify candidate legal authorities. The sections may then be merged or omitted based on the rules. For example, the rules may be configured to merge all sections of the input data relevant to identifying candidate legal authorities and omit those sections determined to be not relevant to identifying candidate legal authorities. The omission of irrelevant portions of the input data (e.g., a signature block, a table of contents, non-argument sections, etc.) may reduce the computational time required to generate the set of features from the input data, as well as eliminate text that could introduce potential noise into the candidate legal authorities that are ultimately identified based on the set of features. It is noted that the exemplary rules described above have been provided by way of illustration, rather than by limitation and that rules utilized in accordance with the present disclosure may include other types of rules and techniques suitable for detecting relevant portions of the input data from which features may be extracted in connection with identifying legal authorities for input data that does not contain citations. For example, a machine learning model may be trained to identify sections within the input data and classify the sections as being relevant for feature extraction in connection with identifying a set of candidate legal authorities relevant to the input data.

Once the segments are identified, the ML model may be used to identify a set of features based on content of the identified segments within the input data 210. For example, the ML model may identify keywords, phrases, and other portions of the input data 210 as being relevant for use in searching for citations to legal authority. As a non-limiting example, the ML model may be a bag of words model trained to identify relevant words within the input data 210 based on the occurrence of words in the input data 210, and/or the frequency by which words occur in the input data 210. For example, where the input data 210 includes a document, the bag of words model may analyze the identified segments of the document to identify the words and the frequencies at which each word occurs in the document. In an aspect, the words and their respective frequencies may be obtained via the above-described NLP processing, such as through tokenization (e.g., a vector representing each word in the relevant segments) and vectorization (e.g., a vector representing the frequency for each word). The bag of words may be utilized to identify a set of features based on the input data 210 and more specifically, the words and word frequencies extracted from the segments identified based on the set of segmentation rules. For example, when a certain word, combination of words, or frequency of words/word combinations is identified within the extracted segments, the bag of words model may determine that a particular legal issue is present or a particular set of facts is detected. The set of features identified by the bag of words model may then be output as a set of features 240. It is noted that using a bag of words technique provides a low-computational cost and low time of execution method to extract features that provide quality search results (e.g., candidate legal authorities relevant to the set of features), which is an important consideration when operating a legal citation platform where searches need to be run quickly and results need to be of good quality. For example, the extracted set of features may produce a set of candidate legal authorities that have a lot of relevant hits (i.e., candidate legal authorities identified as relevant to the set of extracted features) that drop off slowly in terms of quality, rather than a bad search that has a few strongly relevant hits but then decays rapidly (i.e., produces many irrelevant candidate legal authorities).

Returning to FIG. 1, the computing device 110 may include a search engine 122. Search engine 122 may be configured to receive the outputs of the data segmentation engine 120 (e.g., the set of features 240 of FIG. 2) and to generate a query that may be used to search a data source (e.g., the one or more databases 118 or the data source(s) 140). The search may be configured to identify candidate legal authorities relevant to the legal issue(s) and/or facts included in the set of features output by the data segmentation engine 120. For example, the candidate legal authorities may include or correspond to case law documents, statutes, administrative rules, and the like. In an aspect, the legal documents may also include other types of potentially relevant documents, such as, for example, legal briefs, legal filings, and/or secondary source materials such as journal articles, news articles, and so on.

To illustrate and referring again to FIG. 2, the search engine 122 may be configured to perform a candidate discovery process 250 to identify a set of candidate authorities 250. For example, the search engine 122 may receive the set of features 240 from the segment extraction engine 230 and use the set of features to identify a set of candidate authorities 260 from one or more data sources (e.g., the one or more databases 118 and/or the one or more data sources 140 of FIG. 1). The process of identifying the candidate set of authorities 260 may be referred to as a search-engine-based discovery process 252 because the search engine 122 may use the set of features 240 to generate one or more queries that may be used to search the one or more data sources. For example, the query may include keywords, phrases, operators (e.g., AND (“term_A AND term_B”), OR (“term_A OR term_B”), and the like) configured to search the one or more data sources in a manner that identifies candidate legal authorities likely to relevant to any legal issue(s) and/or fact(s) defined in the set of features 240.

It is noted that query generation has been described as one technique that may be employed in the candidate discovery process 250 by way of illustration, rather than by way of limitation and that other candidate discovery techniques may be used. For example, the candidate discovery process 250 may utilize an ML model or knowledge graph to identify the set of candidate authorities 260 based on the set of features 240. For example, the ML model may be configured to identify cases relevant to the set of features 240 using clustering techniques. As another example, a knowledge graph of legal authorities may be created, and relevant legal authorities may be selected from the knowledge graph for inclusion in the set of candidate authorities 260 based on a query of the knowledge graph. As another example, the candidate discovery process 250 may also include, for example, an artificial intelligence (AI) process to identify candidate legal authorities, such as a neural embedding approach (e.g., Universal Sentence Encoder (USE)). However, it is noted that that utilizing a neural embedding approach that uses vector searching can be computationally costly. Such approaches may be more effective for shorter texts (e.g., shorter than documents, briefs, memos or drafts of such documents typically tend to be). Notwithstanding these difficulties, a deep learning approach (e.g., neural embedding) may boost the performance of the candidate discovery process, especially for input data having shorter text elements. Thus, multiple techniques may be effective for identifying candidate legal authorities based on a set of inputs or an identified legal issue.

Returning to the example of FIG. 1, the computing device 110 may include a ranking engine 124 configured to output a set of legal authorities based on a given set of input data. For example, the ranking engine 124 may be configured to receive a set of candidate legal authorities (e.g., the set of candidate legal authorities 260 of FIG. 2) and process the set of candidate legal authorities to generate a final set of candidate legal authorities. In an aspect, the final set of candidate legal authorities may be a reduced set of legal authorities relative to the set of candidate legal authorities identified based on the set of features using the techniques described above. To illustrate, and referring back to FIG. 2, a ranking process 270 is shown, which may be performed by the ranking engine 124 of FIG. 1. As explained above, the candidate discovery process 250 may generate a large number of candidate legal authorities 260 based on the set of features 240 identified from the input data 210. Ideally the candidate legal authorities 260 would all be relevant to the legal issues represented by the set of features 240. However, some of the candidate legal authorities 260 may not be entirely relevant or relevant at all. For example, a candidate legal authority may be identified based on a particular set of terms related to a set of facts or a legal issue, but the facts or legal issue may not be relevant to the input data (e.g., a candidate legal authority may have a similar set of facts but address a different legal issue, etc.). Rather than having a researcher manually sift through the set of candidate legal authorities 260, which would be similar to how searches to which the concepts disclosed herein are presently performed, the ranking engine 124 may rank the set of candidate legal authorities 260 to produce a set of final recommended authorities 280, which may be a set of legal authorities that are most relevant to the facts and/or legal issue(s) corresponding to the set of features 240. It is noted that determining the relevance of the set of candidate legal authorities is a non-trivial challenge for legal citation systems, especially when no citations are present to serve as a basis for an expanded search for legal authority (e.g., based on identification of other legal authorities that cite existing or known legal authorities).

In an aspect, the ranking process 270 may be configured to reduce or prune the set of candidate legal authorities 260 in addition to or as part of the ranking process. For example, the candidate legal authorities may include some less relevant or irrelevant legal authorities due to the lack of any known citations to one or more legal authorities relevant from the input data 210 and the reliance on contextual and semantic analysis of the input data 210 (e.g., using bag of words, segmentation, etc.). As an example, suppose the input data 210 was a memo seeking the answer to a question along the lines of “Whether a castle doctrine self-defense law would extend to a converted garage.” In such a scenario the set of candidate legal authorities 260 may include zoning cases related to garage conversions, which may share some similarities with respect to specific aspects of the input (e.g., garage conversions), but such a result may not be relevant to the legal issues raised in the question presented. To eliminate less relevant results from the set of final recommended authorities 280, the ranking process 270 may be configured to prune the set of candidate legal authorities 260. As can be appreciated from the foregoing, the pruning process may reduce the set of candidate legal authorities to a manageable number, as well as eliminate noise from the candidate legal authorities, producing a set of final recommended authorities 270 that are most relevant to the legal issues and facts extracted from the input data 210. In other implementations, pruning may not remove candidate legal authorities from the set of candidate legal authorities, but may instead rank less relevant candidate legal authorities lower in the set of final recommended authorities 270. Exemplary aspects of performing pruning are described in more detail below.

To further illustrate operations of the ranking process 270, the ranking engine 124 may be configured to perform one or more ranking processes prior to the pruning. For example, the ranking process 270 may include a supervised ML algorithm configured to classify and/or rank candidate legal authorities. As a non-limiting example, FIG. 2 shows a support vector machine (SVM) 272 being used. Additionally, the ranking process 270 may utilize additional ML models to refine the ranking, such as a gradient boosting machine (GBM) thresholding model 274, which may be configured to prevent overfitting among ranked results. It is noted that the decision spaces utilized by the SVM and GBM may support different types of decisions and considerations and by using them both in combination, additional types of analysis of the candidate legal authorities and their relevance to the input data may be considered, improving the overall quality of the rankings and enabling legal authorities to be presented to the researcher in a manner such that more relevant legal authorities are ranked higher and presented earlier in the rankings than less relevant legal authorities.

While the ML algorithms identified above may be suitable when the input data 210 contains citations, additional techniques may be used by the ranking engine 124 to improve the set of final recommended authorities 280 when the input data 210 does not contain citations. To improve the results, the ranking process 270 may include a pruning engine 276. The pruning engine 276 may be configured to rank the set of candidate legal authorities based on the presence and/or absence of certain keywords within the set of results. For example, the set of features may be classified into a set of feature classifications and the pruning engine 276 may be configured to classify the candidate legal authorities in a similar manner. The classifications may then be compared to identify legal authorities having classifications that correspond to one or more classifications of the set of features extracted from the input data. The strength of the correspondence between the feature classifications and the legal authority classifications may then be used to rank or re-rank the set of legal authorities (e.g., the ranked set of legal authorities output as a result of the SVM and GBM described above). In an aspect, the pruning engine 276 may be configured to identify relevant classifications. As a non-limiting example, the classifications used by the pruning engine 276 may include KeyNumbers (e.g., Westlaw KeyNumbers) identified from the input data 210, from the set of features 240 extracted from the input data 210, and/or from the set of candidate legal authorities. For example, all or a portion of the candidate legal authorities may include or be associated with headnotes, which may be associated with KeyNumbers. Such information may then be used to compare each candidate legal authority to the set of features (or the KeyNumbers associated with the set of features) in a uniform manner. Also, the use of KeyNumbers may eliminate some of the extraneous results that may otherwise be observed (e.g., because KeyNumbers may correspond to specific legal principles, fact patterns, or both). In some additional implementations, classifications including KeyNumbers may be identified from a database or a data model. For example, legal authority documents (e.g., case law documents, journal articles, statutes, treatises, and the like) may be analyzed when created to generate a set of classifications that may be stored in a database. This may enable determination of classifications corresponding to each candidate legal authority quickly, enabling the final rankings to be determined and the final legal authorities presented to the user more quickly and with reduced computational cost (e.g., requiring fewer computing or processing resources and memory resources) as compared to if the classifications were determined each time a search was performed in the manner described herein.

In an exemplary aspect, the pruning engine 276 may be configured to model or classify the extracted features 210 as paragraphs of sentences, or, in terms of KeyNumbers, as lists of lists of lists of KeyNumbers. Similarly, the set of candidate legal authorities may be modeled as lists of headnotes, and the headnotes may themselves be modeled as lists of KeyNumbers. In other words, input data 210 (e.g., an input document or information extracted from an input document, such as the set of features 240) may be modeled as a set of KeyNumbers. A set of KeyNumbers associated with each of the set of candidate legal authorities (e.g., legal documents) may also be identified, and the two sets of KeyNumbers may be compared to measure the relevance between a particular candidate legal authority and the input data 210. For example, a legal document, such as a case law document, may be associated with Headnotes, which may each be associated with one or more KeyNumbers. In such an implementation, the KeyNumbers may be compared to determine the relevancy of a particular legal document to the input data 210. For example, suppose the input data 210 (or the set of features 240 extracted from the input data 210) included 5 sentences and there were 3 KeyNumbers common to those 5 sentences. If a given candidate legal authority is associated with a set of Headnotes that relate to some of those 3 KeyNumbers then it may be determined that the candidate legal authority is relevant to the input data 210 and it may be retained within the set of final recommended authorities 280. In an aspect, a relevance score indicating a measure of similarity between the KeyNumbers associated with the input data 210 and the KeyNumbers associated with each candidate legal authority may be generated and candidate legal authorities falling below a threshold similarity may be removed (i.e., pruned) from the set of final recommended authorities 280. It is noted that while the example described above illustrates classification of the features using KeyNumbers, other types of classifications may be used to associate features of the input data to features in the candidate legal authorities in a manner that enables evaluation of the similarity between the classifications of the features and the candidate legal authorities.

While the pruning engine 276 has been described in the example above as identifying and/or comparing KeyNumbers corresponding to input and candidate documents, other methods may be used to evaluate the relevance of the candidate legal authorities 260 to the set of features 240. It is noted that Westlaw KeyNumbers may provide an excellent structure for eliminating extraneous results ranked purely based on keywords. This is because KeyNumbers are already associated with points of law, which is a weakness of techniques limited to keyword analysis (e.g., techniques that only use keywords may result in fact/legal issue mismatches as in the example above related to garage conversions). Thus, the KeyNumber ranking technique outlined above enables identification of potential matching problems resulting from identification of candidate legal authorities with some factual similarity to the input data 210, but which diverge (sometimes significantly) from one or more points of law associated with the input data 210.

As shown above and referring back to FIG. 1, the functionality provided by the segmentation engine 120, the search engine 122, and the ranking engine 124 provides an enhanced process and workflow that enables a set of legal authorities to be identified from a set of input data despite the input data not including citations to legal authority. Furthermore, the segmentation engine 120 provides functionality to enable analysis of input data that has incomplete or missing structural elements, thereby enabling relevant portions of the input data to be located and analyzed for feature extraction. Additionally, the search engine 122 enables candidate legal authorities to be identified based on the set of features output by the segmentation engine 120. As noted above, the candidate legal authorities may include relevant results (e.g., results that relate to facts and points of law included in the set of extracted features), as well as results that are less relevant (e.g., due to fact/legal issue mismatches or other issues). To improve the set of legal authorities output to the searcher, the ranking engine 124 provides functionality to rank the candidate legal authorities and then filter or prune the candidate legal authorities using various techniques. For example, SVM and GBM techniques may be configured to utilize keyword-based techniques to perform an initial ranking of the set of candidate legal authorities. However, as explained above, purely keyword-based techniques may result in the final set of legal authorities include results that are not actually relevant to the input data. To address this problem, the ranking engine 124 is configured to utilize a pruning engine that is configured to efficiently compare the input data and candidate legal authorities based on points of law and legal issues, thereby bridging the gap that would otherwise be present if keywords alone were used.

Once generated, the set of final recommended authorities may be output to the researcher. For example, the ranked set of final recommended authorities may be output to a graphical user interface (GUI), such as a GUI provide via a web page or other type of application (e.g., a web page or application of the computing device 130, which may be a researcher device). In an aspect, set of legal authorities may be output in a list format according to the final rankings determined by the ranking engine 124. In an aspect, a summary of each final recommended authority may also be displayed within the GUI. In an aspect, the set of final recommended authorities may be output as part of a message (e.g., by an email or SMS message). Additionally, or alternatively, the set of final recommended authorities may be stored in a memory and/or a database, such as the one or more database 118 or a database stored at a memory of the computing device 130. In an aspect, each final recommended authority may be displayed in connection with an interactive element, such as a uniform resource locator (URL) that may be activated to view the corresponding legal authority (e.g., a .pdf or other version of the legal authority).

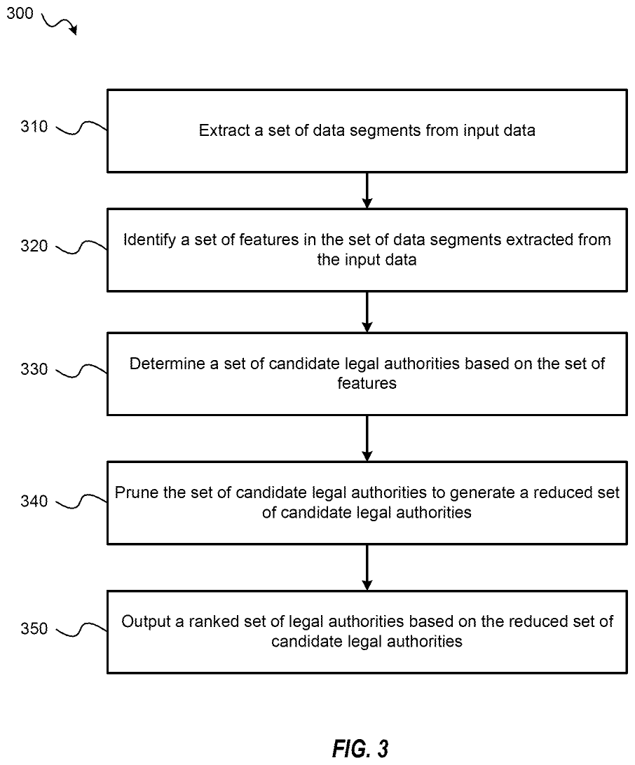

Referring to FIG. 3, of an exemplary method for performing machine-learning based data segmenting, candidate discovery, and candidate ranking in accordance with aspects of the present disclosure is shown as a method 300. In an aspect, steps of the method 300 may be performed by a computing device, such as the computing device 110 of FIG. 1. Additionally, the steps of the method 300 may be stored as instructions (e.g., the instructions 116 of FIG. 1) that, when executed by one or more processors (e.g., the one or more processors 112 of FIG. 1), cause the one or more processors to perform the method 300 in accordance with the concepts described herein. Instructions may be stored in a memory and/or on a non-transitory computer-readable medium. It is noted that the method 300 may be performed via other implementations as well, such as via implementation on cloud-based logic 162 of FIG. 1.

At step 310, the method 300 includes extracting, by one or more processors, a set of data segments from input data. The input data may include or correspond to information associated with one or more legal issues. In some implementations, the input data does not contain citations to legal authorities. At step 320, the method 300 includes identifying, by the one or more processors, a set of features in the set of data segments extracted from the input data. The set of features may include or correspond to the one or more legal issues. For example, the set of features may be related to one or more points of law, a set of facts, a jurisdiction, or some combination thereof. In an implementation, steps 310 and/or 320 may be performed by the data segmentation engine 120 of FIG. 1, as has been described above with reference to FIGS. 1 through 3.

At step 330, the method 300 includes determining, by the one or more processors, a set of candidate legal authorities based on the set of features. For example, the determining of step 330 may be performed by the search engine 122 of FIG. 1, as discussed above with reference to FIGS. 1 and 2. In an aspect, the set of candidate legal authorities may be determined based on a query of a data source (e.g., the one or more databases 118 or the data sources 140 of FIG. 1). The query of the data source may be based on the set of features. In an aspect, the set of candidate legal authorities may include legal documents. For example, the set of candidate legal authorities may include statutes, case law documents, administrative rules, and so on.

At step 340, the method 300 includes pruning, by the one or more processors, the set of candidate legal authorities to generate a reduced set of candidate legal authorities. As explained above with reference to FIGS. 1 and 2, pruning the candidate legal authorities may be performed by the ranking engine 124 of FIG. 1. At step 350, the method 300 includes outputting, by the one or more processors, a ranked set of legal authorities based on the reduced set of candidate legal authorities. In an aspect, the outputting of the ranked set of legal authorities may be performed as described above with reference to FIGS. 1 and 2.

In some aspects, the method 300 may further include converting the input data to a machine readable format via natural language processing prior to extracting the set of data segments. For example, converting the input data to a machine readable format may enable more uniform processing and may promote system efficiency. In an aspect, converting the input data to a machine readable format may be performed by the computing device 110 as described above with respect to FIGS. 1 and 2.

In an aspect, the input data of the method 300 may include jurisdiction information designating one or more jurisdictions of interest. Some exemplary implementations of a jurisdiction information have been described above with respect to FIGS. 1 and 2. In some implementations, the extracting of step 310 may be based at least in part on the one or more jurisdictions of interest. Similarly, the set of candidate authorities determined in step 330 may be associated with the one or more jurisdictions of interest. For example, the set of candidate authorities may include or correspond to a treatment of one or more legal issues within the one or more jurisdictions of interest.

In some aspects, the extracting of step 310 of the method 300 may further include determining section boundaries and headings from the input data. In some aspects, the input data of the method 300 may include an email, a letter, a pleading, a court filing, a brief, an article, a memo, a draft version of one of the preceding types of input data, or a combination thereof. Further examples of these aspects have been described above relative to FIGS. 1 through 2.

In an aspect, pruning the set of candidate legal authorities as in step 340 in method 300 may further include filtering the set of candidate legal authorities based on at least one Westlaw® Key Number corresponding to the one or more points of law. For example, in an aspect described in greater detail above with respect to the ranking engine 124 of FIG. 1 and the ranking process 270 of FIG. 2, the candidate legal authorities may be filtered based on the at least one Westlaw® KeyNumber corresponding to the one or more points of law.

In some implementations, the method 300 may further include, prior to the pruning of step 340, identifying keywords within the set of data segments and ranking the set of set of candidate authorities based at least in part on the keywords. Aspects including these implementations have been discussed above relative to FIGS. 1 and 2. In an aspect, the ranking may be performed simultaneously with the pruning. Alternatively, in an aspect the pruning may be performed before ranking. For example, the ranking engine 124 of FIG. 1 may be configured to rank candidate legal authorities after they have been pruned for relevance.

In some implementations, the method 300 may further include applying a neural language model to the input data, the neural language model configured to prioritize candidate legal authorities from the set of candidate legal authorities corresponding to the one or more points of law over candidate legal authorities corresponding to the set of facts.

The foregoing discussion has identified several systems, apparatuses, and methods for receiving input data, extracting data segments and/or features from the input data, and identifying candidate legal authorities based on the input data. These systems, apparatuses, and methods have the potential to elevate and streamline the legal research process. For example, a legal researcher using systems described in aspects of this disclosure, may be able to identify legal issues more quickly and kickstart the process of analyzing the law as it pertains to a set of facts. More so, the methods and systems discussed herein have greatly expanded the scope of the kinds of input data that can be searched. For example, aspects of this disclosure have enabled the input data of a search system to include emails, documents, letters, pleadings, case filings, and/or drafts of these or other kinds of input data. This has broadened the scope of the kinds of possible inputs that can be accepted by legal search systems. The systems, methods, and apparatuses described with respect to aspects of this disclosure are configured to produce meaningful, relevant results based on the numerous possible forms of input data.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

Functional blocks and modules in FIGS. 1-3 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within a percentage of” what is specified, where the percentage includes 0.1, 1, 5, and 10 percent; and the term “approximately” may be substituted with “within 10 percent of” what is specified. The phrase “and/or” means “and” or “or.”

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A system comprising,
a memory; and
one or more processors coupled to the memory, the one or more processors configured to perform steps, comprising:
extracting, by the one or more processors, a set of data segments from input data, wherein the input data comprises information associated with one or more legal issues and does not contain citations to legal authorities;
identifying, by the one or more processors, a set of features in the set of data segments extracted from the input data, the set of features corresponding to the one or more legal issues and related to one or more points of law, a set of facts, or a combination thereof;
determining, by the one or more processors, a set of candidate legal authorities based on the set of features, wherein the set of candidate legal authorities are determined based on a query of a data source based on the set of features, and wherein the set of candidate legal authorities comprise legal documents;
pruning, by the one or more processors, the set of candidate legal authorities to generate a reduced set of candidate legal authorities; and
outputting, by the one or more processors, a ranked set of legal authorities based on the reduced set of candidate legal authorities.

2. The system of claim 1, further comprising converting the input data to a machine readable format via natural language processing prior to extracting the set of data segments.

3. The system of claim 1, wherein the input data comprises jurisdiction information designating one or more jurisdictions of interest, and wherein the extracting is based at least in part on the one or more jurisdictions of interest, wherein the set of candidate authorities are associated with the one or more jurisdictions of interest, and wherein the set of candidate authorities correspond to a treatment of the one or more legal issues within the one or more jurisdictions of interest.

4. The system of claim 1, wherein the extracting comprises determining section boundaries and headings from the input data, and wherein the input data comprises an email, a letter, a pleading, a court filing, a brief, an article, a memo, a draft version of one of the preceding types of input data, or a combination thereof.

5. The system of claim 1, wherein pruning the set of candidate legal authorities comprises filtering the set of candidate legal authorities based on at least one Westlaw® Key Number corresponding to the one or more points of law.

6. The system of claim 1, further comprising, prior to the pruning:
identifying keywords within the set of data segments; and
ranking the set of set of candidate authorities based at least in part on the keywords.

7. The system of claim 1, further comprising applying a neural language model to the input data, the neural language model configured to prioritize candidate legal authorities from the set of candidate legal authorities corresponding to the one or more points of law.

8. A method, comprising:
extracting, by the one or more processors, a set of data segments from input data, wherein the input data comprises information associated with one or more legal issues and does not contain citations to legal authorities;
identifying, by the one or more processors, a set of features in the set of data segments extracted from the input data, the set of features corresponding to the one or more legal issues and related to one or more points of law, a set of facts, or a combination thereof;
determining, by the one or more processors, a set of candidate legal authorities based on the set of features, wherein the set of candidate legal authorities are determined based on a query of a data source based on the set of features, and wherein the set of candidate legal authorities comprise legal documents;
pruning, by the one or more processors, the set of candidate legal authorities to generate a reduced set of candidate legal authorities; and
outputting, by the one or more processors, a ranked set of legal authorities based on the reduced set of candidate legal authorities.

9. The method of claim 8, further comprising converting the input data to a machine readable format via natural language processing prior to extracting the set of data segments.

10. The method of claim 8, wherein the input data comprises jurisdiction information designating one or more jurisdictions of interest, and wherein the extracting is based at least in part on the one or more jurisdictions of interest, wherein the set of candidate authorities are associated with the one or more jurisdictions of interest, and wherein the set of candidate authorities correspond to a treatment of the one or more legal issues within the one or more jurisdictions of interest.

11. The method of claim 8, wherein the extracting comprises determining section boundaries and headings from the input data, and wherein the input data comprises an email, a letter, a pleading, a court filing, a brief, an article, a memo, a draft version of one of the preceding types of input data, or a combination thereof.

12. The method of claim 8, wherein pruning the set of candidate legal authorities comprises filtering the set of candidate legal authorities based on at least one Westlaw® Key Number corresponding to the one or more points of law.

13. The method of claim 8, further comprising, prior to the pruning:
identifying keywords within the set of data segments; and
ranking the set of set of candidate authorities based at least in part on the keywords.

14. The method of claim 8, further comprising applying a neural language model to the input data, the neural language model configured to prioritize candidate legal authorities from the set of candidate legal authorities corresponding to the one or more points of law over candidate legal authorities corresponding to the set of facts.

15. A computer program product, comprising:
a non-transitory computer readable medium comprising code for performing steps comprising:
extracting, by the one or more processors, a set of data segments from input data, wherein the input data comprises information associated with one or more legal issues and does not contain citations to legal authorities;
identifying, by the one or more processors, a set of features in the set of data segments extracted from the input data, the set of features corresponding to the one or more legal issues and related to one or more points of law, a set of facts, or a combination thereof;
determining, by the one or more processors, a set of candidate legal authorities based on the set of features, wherein the set of candidate legal authorities are determined based on a query of a data source based on the set of features, and wherein the set of candidate legal authorities comprise legal documents;
pruning, by the one or more processors, the set of candidate legal authorities to generate a reduced set of candidate legal authorities; and
outputting, by the one or more processors, a ranked set of legal authorities based on the reduced set of candidate legal authorities.

16. The computer program product of claim 15, further comprising converting the input data to a machine readable format via natural language processing prior to extracting the set of data segments.

17. The computer program product of claim 15, wherein the input data comprises jurisdiction information designating one or more jurisdictions of interest, and wherein the extracting is based at least in part on the one or more jurisdictions of interest, wherein the set of candidate authorities are associated with the one or more jurisdictions of interest, and wherein the set of candidate authorities correspond to a treatment of the one or more legal issues within the one or more jurisdictions of interest.

18. The computer program product of claim 15, wherein the extracting comprises determining section boundaries and headings from the input data, and wherein the input data comprises an convert.

19. The computer program product of claim 15, wherein pruning the set of candidate legal authorities comprises filtering the set of candidate legal authorities based on at least one Westlaw® Key Number corresponding to the one or more points of law.

20. The computer program product of claim 15, further comprising, prior to the pruning:
identifying keywords within the set of data segments; and
ranking the set of set of candidate authorities based at least in part on the keywords.
